(19) United States
(12) Patent Application Publication
(10) Pub. No.: US 2015/0012644 A1
(43) Pub. Date: Jan. 8, 2015

(54) PERFORMANCE MEASUREMENT METHOD, STORAGE MEDIUM, AND PERFORMANCE MEASUREMENT DEVICE

(71) Applicant: FUJITSU LIMITED, Kawasaki-shi (JP)

(72) Inventor: Atsushi Kubota, Yokohama (JP)

(73) Assignee: FUJITSU LIMITED, Kawasaki-shi (JP)

(21) Appl. No.: 14/294,746

(22) Filed: Jun. 3, 2014

(30) Foreign Application Priority Data
Jul. 2, 2013 (JP) 2013-138821

(51) Int. Cl. H04L 12/26

(52) U.S. Cl. CPC H04L 43/04
USPC 709/224

(57) ABSTRACT

A performance measurement method includes acquiring first time-sequential data including input operation data that is transmitted from a first computer to a second computer, and a first time information indicating a time when the input operation data being transmitted from the first computer, the input operation data being associated with the first time information; acquiring second time-sequential data including drawing processing data that is transmitted from the second computer to the first computer, and a second time information indicating a time when the drawing processing data being transmitted from the second computer, the drawing processing data being associated with the second time information; specifying a similar period in which the input operation data and the drawing processing data are similar; and calculating a difference between the first time information and the second time information corresponding to the similar period as a response time of the drawing processing data.

### CROSS-REFERENCE TO RELATED APPLICATION

This application is based upon and claims the benefit of priority from the prior Japanese Patent Application No. 2013-138821 filed on Jul. 2, 2013, the entire contents of which are incorporated herein by reference.

### FIELD

The embodiments discussed herein are related to a performance measurement method, a storage medium, and a performance measurement device.

### BACKGROUND

Technology has been disclosed that, in a thin client system, determines whether or not a packet has been returned from a server to a client between two packets transmitted from the client to the server, and outputs to the outside that there is a deterioration in quality when a packet has not been returned. Technology has been disclosed that, in a remote desktop system in which a graphical user interface (GUI) of a server is operated from a client, the communication system is selected based on the communication environment between the server and the client. In this technology, a selection is made between either of a system that transmits a command for generating image data corresponding to an operation signal from the client, or a system that transmits the image data itself corresponding to the operation signal from the client, from the server to the client. In addition, technology has been disclosed that, in a multi-hierarchical system in which a plurality of servers cooperate to execute transactions, determines whether or not there is a correlation between the time-sequential transition in the average processing time per one processing of a server belonging to a first hierarchy, and the time-sequential transition in the average processing time per one processing of a server belonging to a second hierarchy. In technology that combines the log data of a computer and data written in a natural language and analyzes the data, technology has been disclosed that associates a sequence of data having a timestamp such as a PC operation log, and a sequence of data constituted by speech or a description having a timestamp.

One indicator for measuring the performance and evaluating the quality of a remote desktop system is the response time from an input operation in a client being performed, to a drawing processing instruction for a screen corresponding to that input operation being returned to the client. The quality of the user experience in the remote desktop system improves as this response time shortens. As related art, for example, Japanese Laid-open Patent Publication No. 2010-079329, Japanese Laid-open Patent Publication No. 2010-087625, Japanese Laid-open Patent Publication No. 2011-258057, and Japanese Laid-open Patent Publication No. 2012-103787 and so forth have been disclosed.

However, an input operation in a client in a remote desktop system and the return of a drawing instruction by a service server do not necessarily correspond on a one-to-one basis. There are also no identifiers and so forth that associate an input operation and an instruction for drawing processing for a screen corresponding to the input operation. Therefore, measuring response times has been difficult.

### SUMMARY

According to an aspect of the invention, a performance measurement method includes acquiring first time-sequential data including input operation data that is transmitted from a first computer to a second computer, and a first time information indicating a time when the input operation data being transmitted from the first computer, the input operation data being associated with the first time information; acquiring second time-sequential data including drawing processing data that is transmitted from the second computer to the first computer, and a second time information indicating a time when the drawing processing data being transmitted from the second computer, the drawing processing data being associated with the second time information; specifying a similar period in which the input operation data and the drawing processing data are similar; and calculating a difference between the first time information and the second time information corresponding to the similar period as a response time of the drawing processing data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an overall configuration diagram of an example of a remote desktop system;

FIG. 2 is a drawing depicting an example of data transmitted and received between a client and a service server;

FIG. 3 is a drawing depicting an example of the hardware configuration of a capture server;

FIG. 4 is a drawing depicting an example of the functional structure of a capture server and data stored in a storage unit;

FIG. 5 is a drawing depicting an example of a communication log table;

FIG. 6 is a drawing depicting an example of a frame unit communication log table;

FIG. 7A is a drawing depicting an example of an input operation table;

FIG. 7B is a drawing depicting an example of a drawing processing table;

FIG. 8 is a drawing depicting an example of an input/drawing correspondence table;

FIG. 9A is a drawing depicting an example of input operation time-sequential data;

FIG. 9B is a drawing depicting an example of drawing processing time-sequential data;

FIG. 9C is a drawing depicting an example of a maximum permissible number;

FIG. 10 is a drawing depicting an example of similarity data;

FIG. 11 is a drawing depicting an example of a response time table;

FIG. 12 is a flowchart depicting an example of processing executed by a capture unit and an L7 analysis unit;

FIG. 13 is a flowchart depicting an example of processing executed by a time-sequential data generation unit;

FIG. 14 is a flowchart depicting an example of processing executed by an association unit;

FIG. 15 is a flowchart depicting an example of processing executed by a response time calculation unit;

FIG. 16 is a drawing depicting an example of a screen change when the down cursor key is pressed;

FIG. 17 is a drawing depicting an example of a similarity calculation method;

FIG. 18 is a drawing depicting an example of the functional structure of a capture server and data stored in a storage unit;

FIG. 19 is a drawing depicting an example of pixel rewrite incidence data;

FIG. 20 is a drawing depicting an example of an input/drawing correspondence table;

FIG. 21 is a flowchart depicting an example of processing executed by a time-sequential data generation unit; and

FIG. 22 is a drawing depicting an example of input operation time-sequential data.

### DESCRIPTION OF EMBODIMENTS

### Embodiment 1

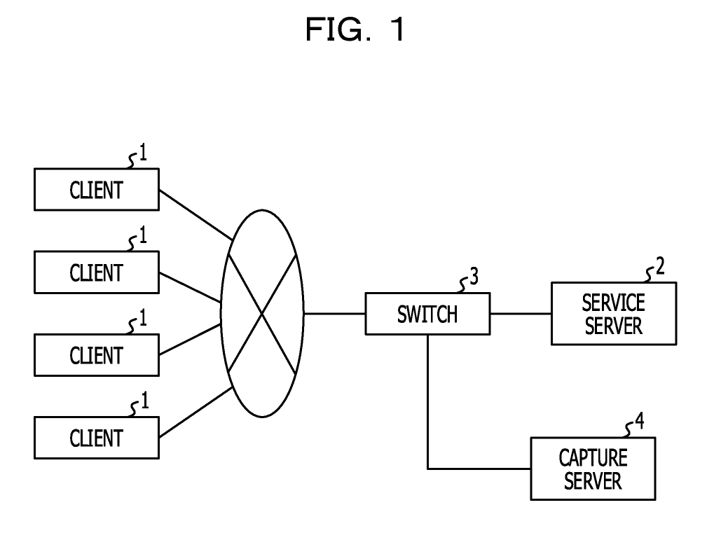

FIG. 1 is a drawing depicting an example of the overall configuration of a remote desktop system embodying the aforementioned technology.

A remote desktop system of the present embodiment includes clients 1, a service server 2, a switch 3, and a capture server 4. The clients 1, the service server 2, and the capture server 4 are computers including at least a central processing unit (CPU) and a storage device. The clients 1, the service server 2, and the capture server 4 are connected to each other by a network and via the switch 3.

In a client 1, input operations (for example, operations using a keyboard or a mouse or the like) are performed by a user or the like. In contrast, the service server 2 executes processing corresponding to an input operation in this client 1. The service server 2 then issues an instruction to the client 1 for drawing processing for a screen that indicates the processing result. The processing executed by the service server 2 corresponds to a variety of processing that is executed by a computer in accordance with input operations, such as the display of characters corresponding to a key input for example, the movement of a pointer accompanying a mouse movement operation, and the scrolling of a screen and so forth.

The clients 1 and the service server 2 repeat a series of processing such as the following. First, when an input operation is performed by the user or the like via an input device, a client 1 transmits, to the service server 2, input operation data indicating the content of that input operation. The service server 2 performs processing, as occasion calls, based on the input operation data received from the client 1. The service server 2 then returns, to the client 1, drawing processing data indicating instruction content for drawing processing for a screen that is to display a processing result. The client 1 then, based on the drawing processing data received from the service server 2, performs drawing processing, and displays the screen on a display. It is therefore possible for the user or the like who performed the input operation in the client 1 to visually perceive the result of his/her input operation on the screen displayed on the display of the client 1.

The switch 3 is provided with a port mirroring function together with being provided with an ordinary switching function. The switch 3 then performs port mirroring, with respect to the capture server 4, for the input operation data transmitted from the client 1 to the service server 2, and the drawing processing data returned from the service server 2 to the client 1.

The capture server 4 acquires, by capturing, the input operation data and the drawing processing data port mirrored by the switch 3. The capture server 4 then uses the captured input operation data and drawing processing data to calculate a response time from the input operation in the client 1 to a screen that is drawn in accordance with that input operation being returned to the client 1.

In the system of the present embodiment, although there are a plurality of clients 1, it is permissible for there to be one thereof. In the system of the present embodiment, although there is one service server 2 and one capture server 4, it is permissible for there to be a plurality thereof. If there are a plurality of service servers 2 and capture servers 4, it is also possible for each of these to perform distributed processing.

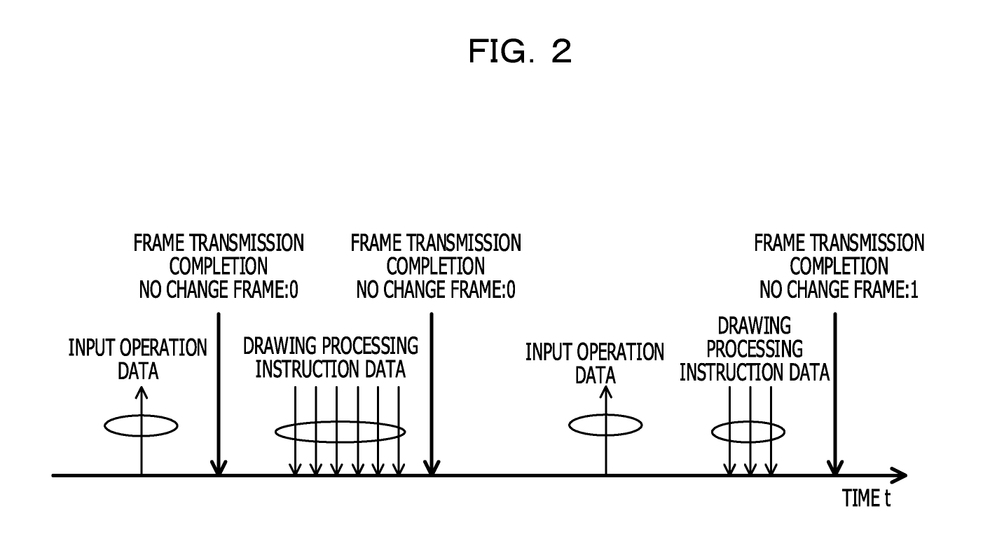

Here, an example of communication data transmitted and received between a client 1 and a service server 2 is described with reference to FIG. 2.

In the example depicted in FIG. 2, the arrows pointing from below to above represent data that is transmitted from the client 1 to the service server 2. The data that is transmitted from the client 1 to the service server 2 includes input operation data.

In contrast, the arrows pointing from above to below represent communication data that is transmitted from the service server 2 to the client 1. The data that is transmitted from the service server 2 to the client 1 includes drawing processing data. The drawing processing data includes a command that indicates the content of the drawing processing. If the drawing processing involves the drawing of a new screen, the drawing processing data includes the screen data to be drawn. Here, the drawing processing data includes frame transmission completion command data in which a command indicates “frame transmission complete”. Frame transmission completion command data indicates that the transmission of drawing processing data for displaying a screen for one frame has been completed. In other words, drawing processing data that is transmitted between one item of frame transmission completion command data and the next item of frame transmission completion command data corresponds to drawing processing data for displaying a screen for one frame.

Incidentally, the service server 2, in principle, does not transmit frame transmission completion command data when an update is not generated in the screen displayed by the client 1. When a screen update is next generated and frame transmission completion command data is transmitted, the service server 2 transmits the number of frames in which frame transmission completion command data has not been transmitted, designated by an argument “NoChangeFrame”. In other words, the argument “NoChangeFrame” indicates the number of frames in which a screen update has not been performed immediately prior thereto. When frame transmission completion command data is being transmitted for frames, the value of “NoChangeFrame” is 0.

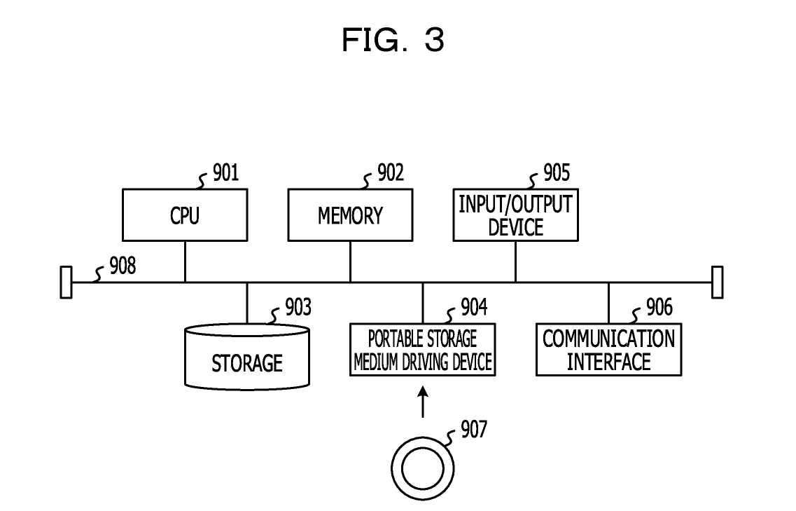

FIG. 3 is a drawing depicting an example of the hardware configuration of an information processing device that functions as the capture server 4. This information processing device includes a processor 901, a memory 902, a storage 903, a portable storage medium driving device 904, an input/output device 905, and a communication interface 906.

The processor 901 includes a control unit, a calculation unit, and an instruction decoder and so forth. An execution unit of the processor 901 follows the instructions of a program decoded by the instruction decoder. When a control signal output by the control unit is received, the processor 901 uses the calculation unit to execute arithmetic/logical operations. The processor 901 is provided with a control register in which various information used for control is stored, a cache in which the content of the memory 902 and so forth that has already been accessed is able to be temporarily stored, and a translation lookaside buffer (TLB) that functions as a cache for a virtual memory page table. The processor 901 may be provided with a plurality of central processing unit (CPU) cores.

The memory 902 is a storage device such as a random-access memory (RAM) for example. The memory 902 is a main memory into which programs executed by the processor 901 are loaded, and also data used for the processing of the processor 901 is stored. The storage 903 is a storage device such as a hard disk drive (HDD) or a flash memory, and stores programs and various data. The portable storage medium driving device 904 is a device that reads data and programs stored in a portable storage medium 907. The portable storage medium 907 is, for example, a magnetic disk, an optical disc, a magneto-optical disc, or a flash memory or the like. The processor 901 executes programs stored in the storage 903 and the portable storage medium 907 while cooperating with the memory 902 and the storage 903. Programs executed by the processor 901 and data to be accessed may be stored in another device capable of communicating with the information processing device. The “storage unit of the capture server 4” in the present embodiment represents at least one of the memory 902, the storage 903, the portable storage medium 907, or the other device capable of communicating with the information processing device.

The input/output device 905 is, for example, a keyboard or the like or a display or the like. The input/output device 905 receives operation instructions according to a user operation or the like, and also outputs processing results produced by the information processing device. The communication interface 906 is, for example, a local area network (LAN) card or the like. The communication interface 906 makes it possible to communicate data with the outside. The aforementioned constituent elements of the information processing device are connected by a bus 908.

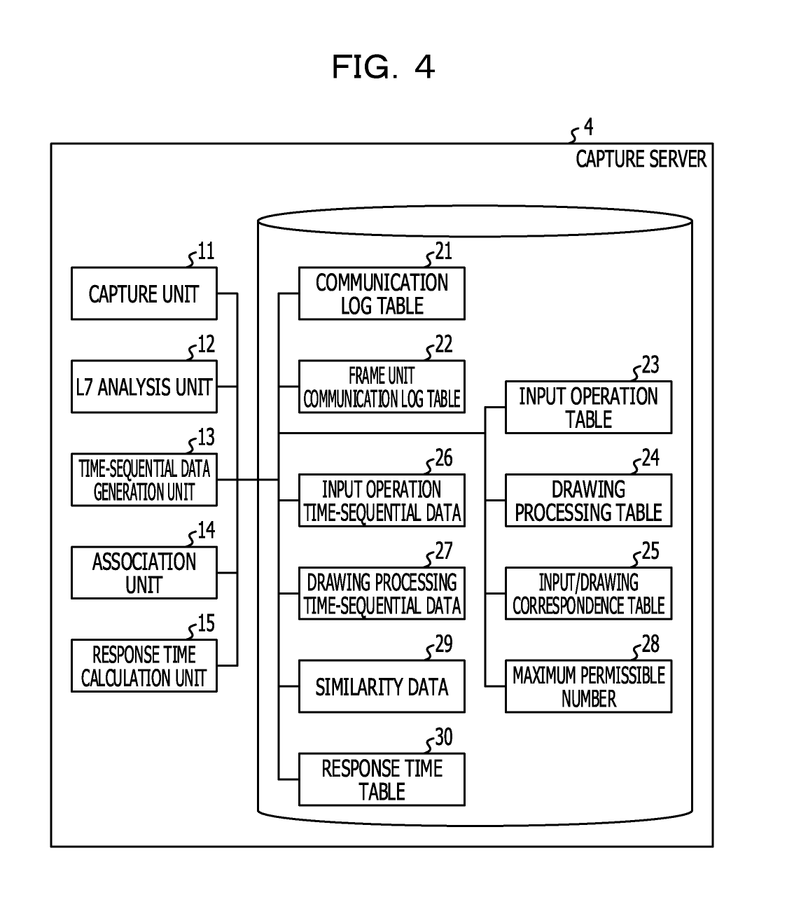

Next, an example of the functional structure of the capture server 4 and the data structure of the data stored in the storage unit of the capture server 4 is described with reference to FIG. 4 to FIG. 11.

FIG. 4 is a drawing depicting the functional structure of the capture server 4 and the data stored in the storage unit.

The capture server 4 includes a capture unit 11, an L7 analysis unit 12, a time-sequential data generation unit 13, an association unit 14, and a response time calculation unit 15, which are realized by programs being installed and executed. The storage unit of the capture server 4 stores a communication log table 21, a frame unit communication log table 22, an input operation table 23, a drawing processing table 24, an input/drawing correspondence table 25, input operation time-sequential data 26, drawing processing time-sequential data 27, a maximum permissible number 28, similarity data 29, and a response time table 30.

The capture unit 11 acquires input operation data transmitted from the client 1 and drawing processing data transmitted from the service server 2, which are port mirrored by the switch 3.

The L7 analysis unit 12 analyzes the input operation data and the drawing processing data (binary data) acquired by the capture unit 11. The L7 analysis unit 12 then converts the data and generates a communication log indicating the content of the input operation data and the drawing processing data, and writes the generated communication log in the communication log table 21.

The capture unit 11 and the L7 analysis unit 12, in other words, acquire the input operation data transmitted from the client 1 and the drawing processing data transmitted from the service server 2. The capture unit 11 and the L7 analysis unit 12 correspond to a data acquisition unit.

The time-sequential data generation unit 13 specifies the occurrence status of input operation data in a predetermined period that is an arbitrary period in which a response time is measured, and of drawing processing data in a period including at least the predetermined period. Specifically, the time-sequential data generation unit 13 generates frame unit communication logs by forming the communication logs written in the communication log table 21 by the L7 analysis unit 12, into groups for each frame. The time-sequential data generation unit 13 then writes the generated frame unit communication logs in the frame unit communication log table 22. The time-sequential data generation unit 13 selects an input operation for which the response time is to be measured. The time-sequential data generation unit 13 then generates input operation time-sequential data 26 that indicates the occurrence status of the input operation data indicating the input operation in question in the frames included in the aforementioned predetermined period. The time-sequential data generation unit 13 then writes the generated input operation time-sequential data 26 in the storage unit. In addition, the time-sequential data generation unit 13 selects the drawing processing that is executed in accordance with the selected input operation in question. The time-sequential data generation unit 13 then generates drawing processing time-sequential data 27 that indicates the occurrence status of the drawing processing data of the drawing processing in question in the frames included in a period including at least the aforementioned predetermined period. The time-sequential data generation unit 13 then writes the generated drawing processing time-sequential data 27 in the storage unit. Here, if there are a plurality of types of drawing processing executed in accordance with the input operation, the time-sequential data generation unit 13 generates the drawing processing time-sequential data 27 for each type of drawing processing. The time-sequential data generation unit 13 corresponds to an occurrence specifying unit.

The association unit 14 specifies a period in which the similarity between the occurrence status of the input operation data in the aforementioned predetermined period and the occurrence status of the drawing processing data is the highest. Specifically, the association unit 14 calculates the similarity between the input operation time-sequential data 26 and the drawing processing time-sequential data 27. At such time, while shifting one frame at a time up to a maximum permissible number, the association unit 14 calculates, for each period corresponding to each shift, the similarity between the input operation time-sequential data 26 corresponding to each frame included in the aforementioned predetermined period, and the drawing processing time-sequential data 27 corresponding to each frame included in the period including the predetermined period. This calculation processing is described later in detail. The association unit 14 then generates similarity data 29 and writes the similarity table 29 in the storage unit. The association unit 14 then specifies the number of frame shifts for which the similarity is the highest. In other words, the association unit 14 specifies a period that is shifted to later than the aforementioned predetermined period by the number of frame shifts for which the similarity is the highest.

Based on the number of frame shifts for which the similarity is the highest specified by the association unit 14, the response time calculation unit 15 calculates and outputs a response time that is the time difference between the transmission time of the drawing processing data generated in the period corresponding to the number of shifts in question, and the transmission time of the input operation data first generated in the aforementioned predetermined period.

Next, the data structure of the data stored in the storage unit of the capture server 4 is described.

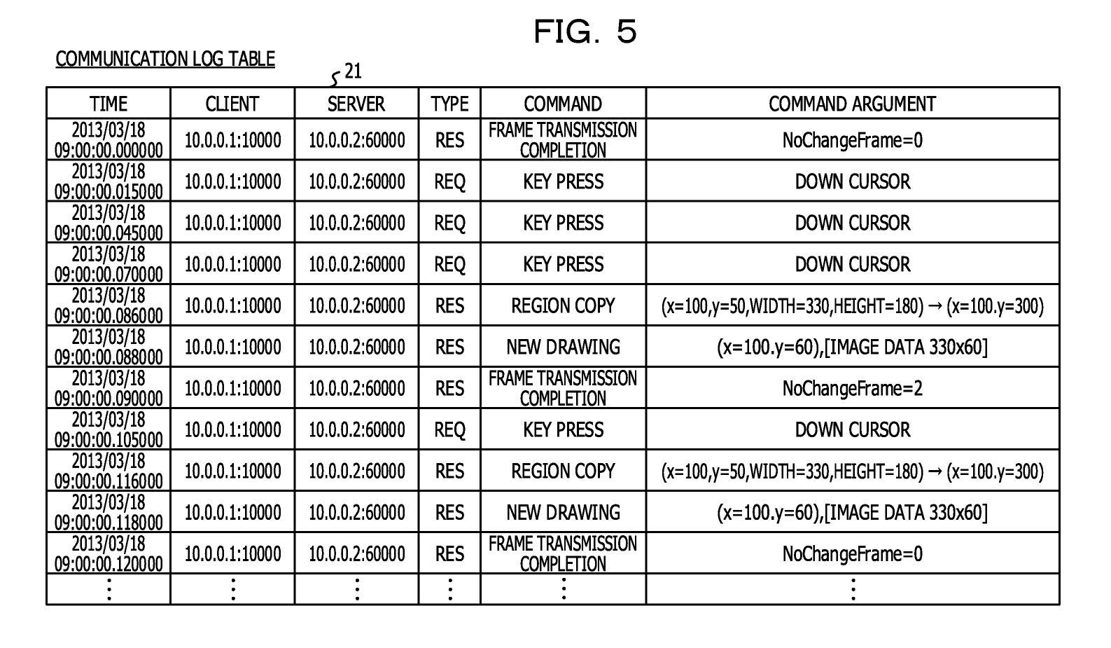

The communication log table 21 is a table in which are recorded communication logs indicating the content of input operation data and drawing processing data transmitted and received between the client 1 and the service server 2. As depicted in FIG. 5, the communication log table 21 includes the headings of the [time] at which data has been transmitted, [client] indicating the IP address and port number of the client 1, [server] indicating the IP address and the port number of the service server 2, [type] indicating input operation data (REQ) from the client 1 or drawing processing data (RES) from the service server 2, [command] indicating the content of a command that is an instruction included in the data, and [command argument] indicating an argument of the command.

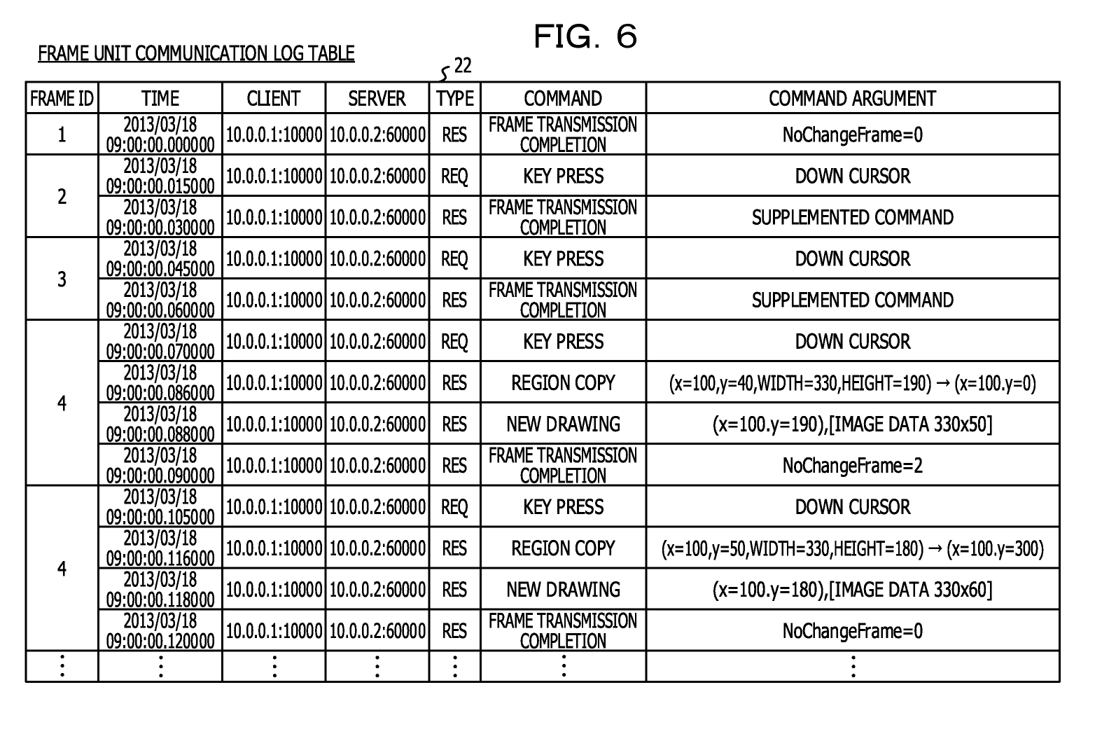

The frame unit communication log table 22 is a table in which is recorded data obtained by the communication logs stored in the communication log table 21 having been formed into groups for each frame. As depicted in FIG. 6, the frame unit communication log table 22 includes the heading of [frame ID] uniquely specifying the frame, in addition to the headings included in the communication log table 21.

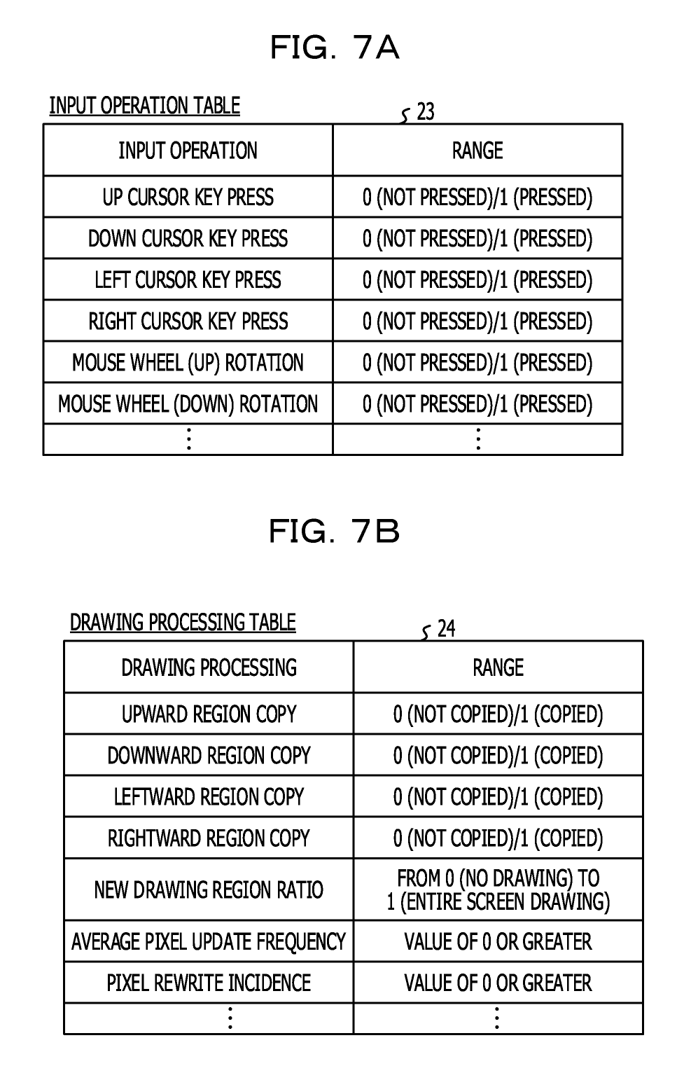

The input operation table 23 is a table in which are recorded data and so forth indicating types of input operations that are input operations in the client 1 and may become response time measurement targets. As depicted in FIG. 7A, the input operation table 23 includes the headings of [input operation] indicating the types of input operations, and [range] indicating the ranges of values that correspond to the type of the input operation in question and indicate the occurrence status of the input operation data. The data of the input operation table 23 is written in advance by a system administrator or the like.

The drawing processing table 24 is a table in which are recorded data and so forth indicating the types of drawing processing for which the similarity with an input operation is calculated. As depicted in FIG. 7B, the drawing processing table 24 includes the headings of [drawing processing] indicating the types of drawing processing for which the similarity with an input operation is calculated, and [range] indicating the ranges of values that correspond to the type of the drawing processing in question and indicate the occurrence status of the drawing processing data. The data of the drawing processing table 24 is written in advance by a system administrator or the like.

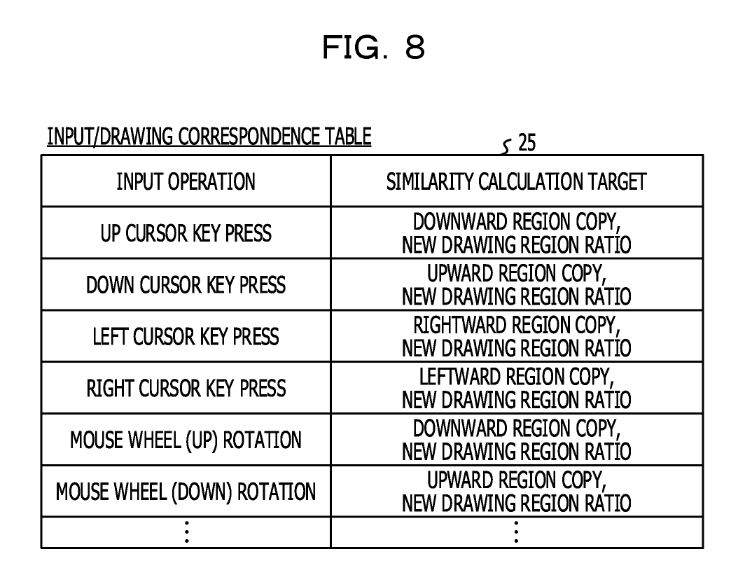

The input/drawing correspondence table 25 is a table having data recorded therein in which the type of an input operation and the type of drawing processing for which the similarity with the input operation in question is calculated are associated. As depicted in FIG. 8, the input/drawing correspondence table 25 includes the headings of [input operation] indicating the types of input operations, and [similarity calculation target] indicating the types of drawing processing for which the similarity with the input operation in question is calculated. The input/drawing correspondence table 25 is written in advance by a system administrator or the like.

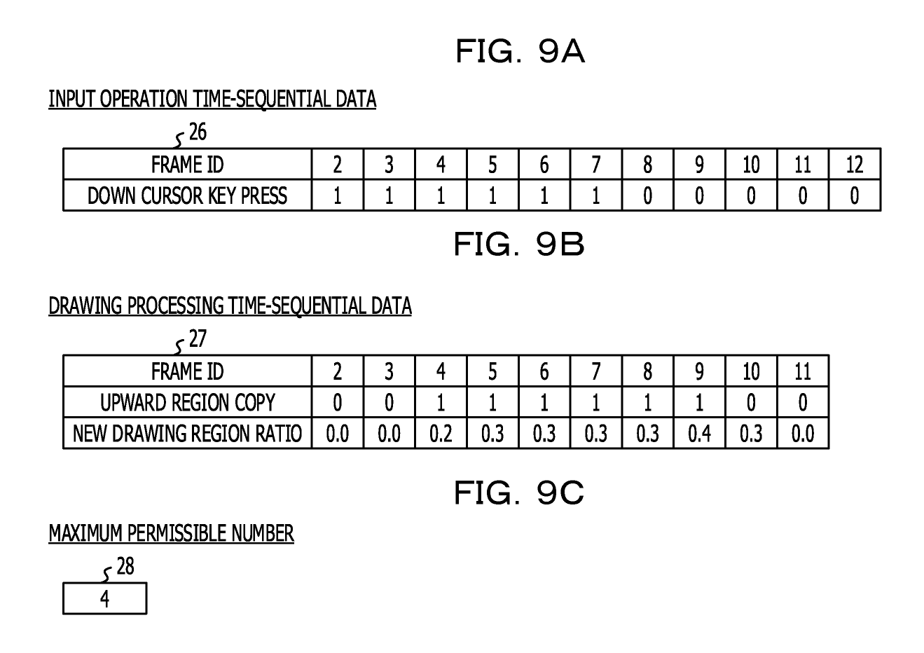

As depicted in FIG. 9A, the input operation time-sequential data 26 is data in which values that indicate the occurrence status of input operation data indicating an input operation which is in a period where response time is measured and is a response time measurement target are retained for each frame.

As depicted in FIG. 9B, the drawing processing time-sequential data 27 is data in which values that indicate the occurrence status of drawing processing data indicating drawing processing which is in a period where response time is measured and for which the similarity with an input operation that is a response time measurement target is calculated are retained for each frame.

As depicted in FIG. 9C, the maximum permissible number 28 is the maximum value for the number of shifts that frames of the input operation time-sequential data 26 and the drawing processing time-sequential data 27 are moved when the association unit 14 calculates the similarity with the occurrence status of input operation data and the occurrence status of drawing processing data (namely, the similarity between the input operation time-sequential data 26 and the drawing processing time-sequential data 27). In other words, the maximum permissible number 28 is the number of frames corresponding to the longest time estimated as a response time (the number obtained by dividing the longest time estimated as a response time by the time of each frame). The maximum permissible number 28 is written in advance by a system administrator or the like.

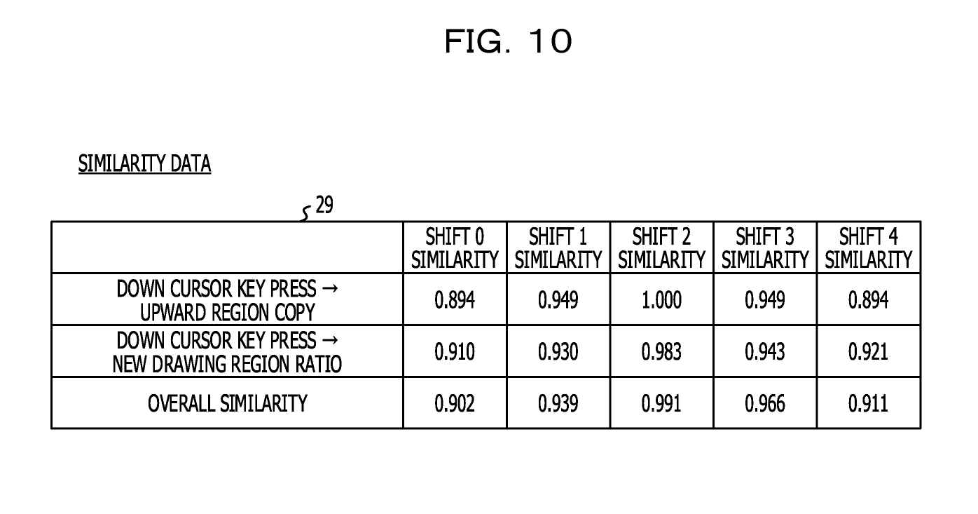

As depicted in FIG. 10, the similarity data 29 is data indicating the similarity between the occurrence status of input operation data and the occurrence status of drawing processing data, for each frame shift. If there are a plurality of types of drawing processing for which the similarity with input operation data is calculated, the similarity data 29 further includes the overall similarity between the occurrence status of input operation data and the occurrence status of drawing processing data for each type of drawing processing, in each frame shift. The details of the overall similarity are described later.

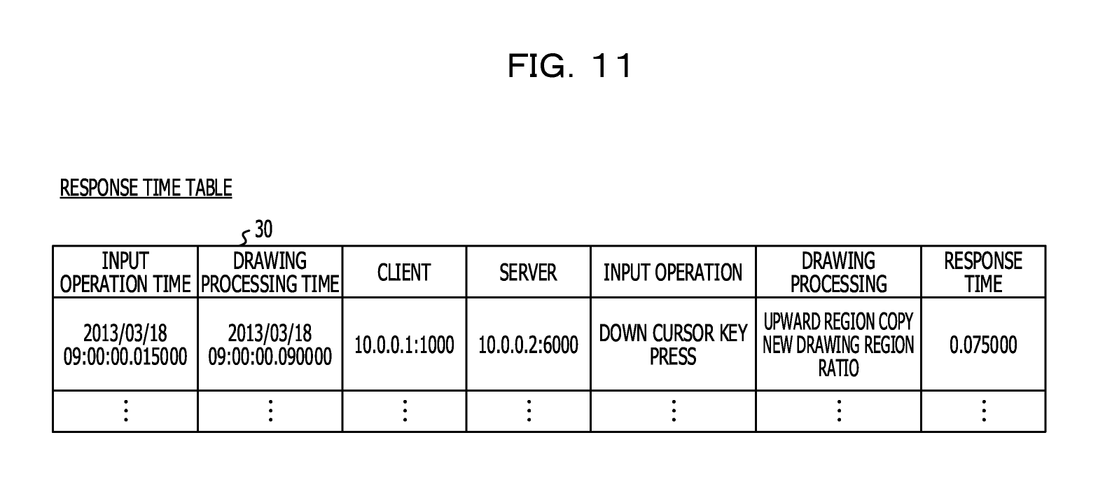

The response time table 30 is a table in which are recorded response times from an input operation in the client 1 being performed, to an instruction for drawing processing for a screen corresponding to that input operation being returned to the client 1. As depicted in FIG. 11, the response time table 30 includes the headings of [input operation time] indicating the time at which input operation data is transmitted from the client 1, [drawing processing time] indicating the time at which drawing processing data is transmitted from the service server 2, [client] indicating the IP address and so forth of the client 1, [server] indicating the IP address and so forth of the service server 2, [input operation] indicating the type of the input operation, [drawing processing] indicating the type of the drawing processing, and [response time] indicating the response time from the input operation to the drawing processing.

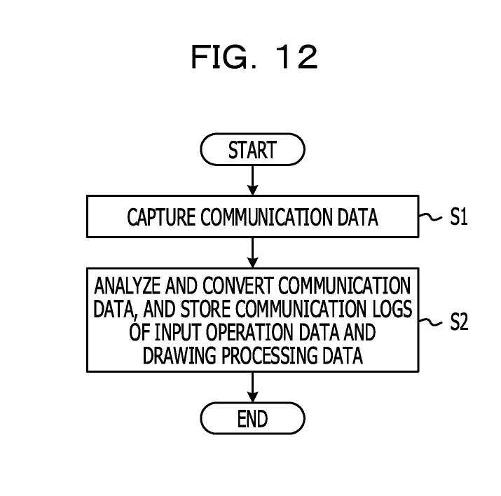

Next, examples of the processing performed by the time-sequential data generation unit 13, the association unit 14, and the response time calculation unit 15 of the capture server 4 are described in further detail using the flowcharts depicted in FIG. 12 to FIG. 15.

First, processing executed by the capture unit 11 and the L7 analysis unit 12 is described using the flowchart depicted in FIG. 12.

In S1, the capture unit 11 captures input operation data transmitted from the client 1 and drawing processing data transmitted from the service server 2, which are port mirrored by the switch 3. At this stage, the input operation data and the drawing processing data are binary data.

In S2, the L7 analysis unit 12 analyzes the binary data captured by the capture unit 11, and converts the data and generates a communication log of input operation data and drawing processing data. The L7 analysis unit 12 then writes the generated communication log in the communication log table 21.

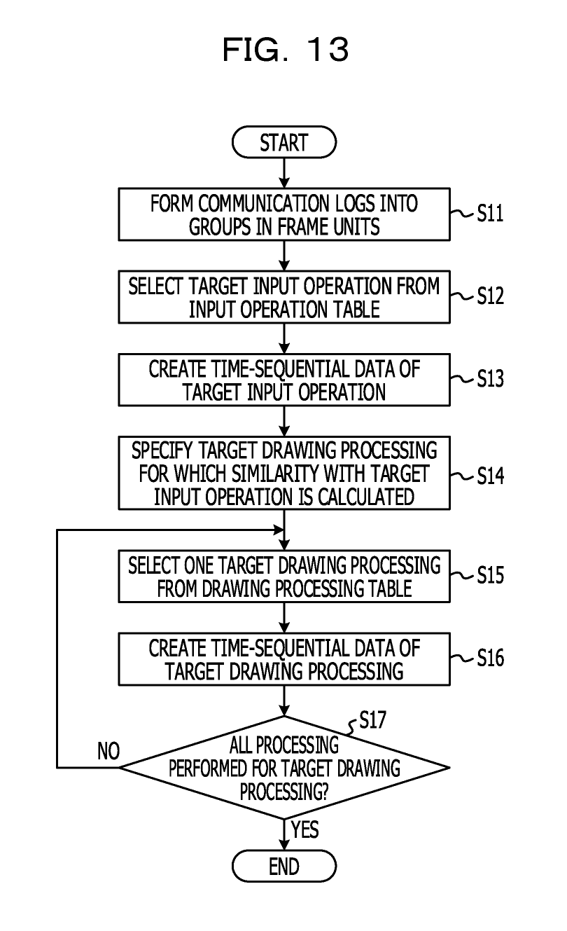

Next, processing executed by the time-sequential data generation unit 13 is described using the flowchart depicted in FIG. 13. This processing is executed in continuation from the aforementioned processing of the capture unit 11 and the L7 analysis unit 12.

In S11, the time-sequential data generation unit 13 forms the communication logs of the communication log table 21 into groups in frame units. The time-sequential data generation unit 13 then generates frame unit communication logs in which a frame ID is assigned to each frame with respect to the communication logs that have been formed into groups in frame units. The time-sequential data generation unit 13 then writes the generated frame unit communication logs in the frame unit communication log table 22. Specifically, the time-sequential data generation unit 13 forms the communication logs of the communication log table 21 into groups in such a way that a communication log in which the frame transmission completion command “NoChangeFrame” is included in the command argument is at the end of each frame. Here, if the value of “NoChangeFrame” is not 0, the time-sequential data generation unit 13 divides the time difference from the immediately preceding frame transmission completion command by the “NoChangeFrame” value+1, and generates and supplements (inserts) a frame supplement record at each of those time intervals.

In S12, the time-sequential data generation unit 13 selects one type (hereafter referred to as the “target input operation”) of input operation to be a response time measurement target, from [input operation] in the input operation table 23. It is possible for the target input operation to be designated by, for example, a system administrator or the like.

In S13, the time-sequential data generation unit 13 refers to the frame unit communication log table 22, and specifies an arbitrary plurality of consecutive frames (hereafter referred to as the “target frame group”) including a frame in which input operation data indicating the target input operation selected from the input operation table 23 in S12 has been generated. In other words, the time-sequential data generation unit 13 specifies an arbitrary period (the aforementioned predetermined period) in which the target input operation has been performed in the client 1. The time-sequential data generation unit 13 then generates input operation time-sequential data 26 that indicates the occurrence status of the input operation data indicating the target input operation in the frames of the target frame group. Specifically, the time-sequential data generation unit 13 refers to the commands and the command arguments of the frame unit communication log table 22, and based on the ranges of the input operation table 23, converts the content of the target input operation performed in the frames into numerical values (normalization).

In S14, the time-sequential data generation unit 13 refers to the input/drawing correspondence table 25, and acquires drawing processing for a similarity calculation target (hereafter referred to as the “target drawing processing”) for which the similarity with the target input operation is to be calculated.

In S15, the time-sequential data generation unit 13 selects one type of target drawing processing acquired in S14, from the drawing processing of the drawing processing table 24.

In S16, with regard to the target frame group and the maximum permissible number (predetermined number) of frames (period including at least the aforementioned predetermined period) continuing from the target frame group, the time-sequential data generation unit 13 refers to the frame unit communication log table 22 and thereby generates drawing processing time-sequential data 27 indicating the occurrence status of drawing processing data that indicates the target drawing processing in the frames. Specifically, the time-sequential data generation unit 13 refers to the commands and the command arguments of the frame unit communication log table 22. The time-sequential data generation unit 13 then, based on the ranges of the input operation table 23, converts the content of the target drawing processing performed in the frames into numerical values (normalization).

In S17, the time-sequential data generation unit 13 determines whether or not all of the processing has been performed for the target drawing processing specified in S14. Processing is finished if all of the processing has been performed for the target drawing processing, or processing returns to S15 if that is not the case.

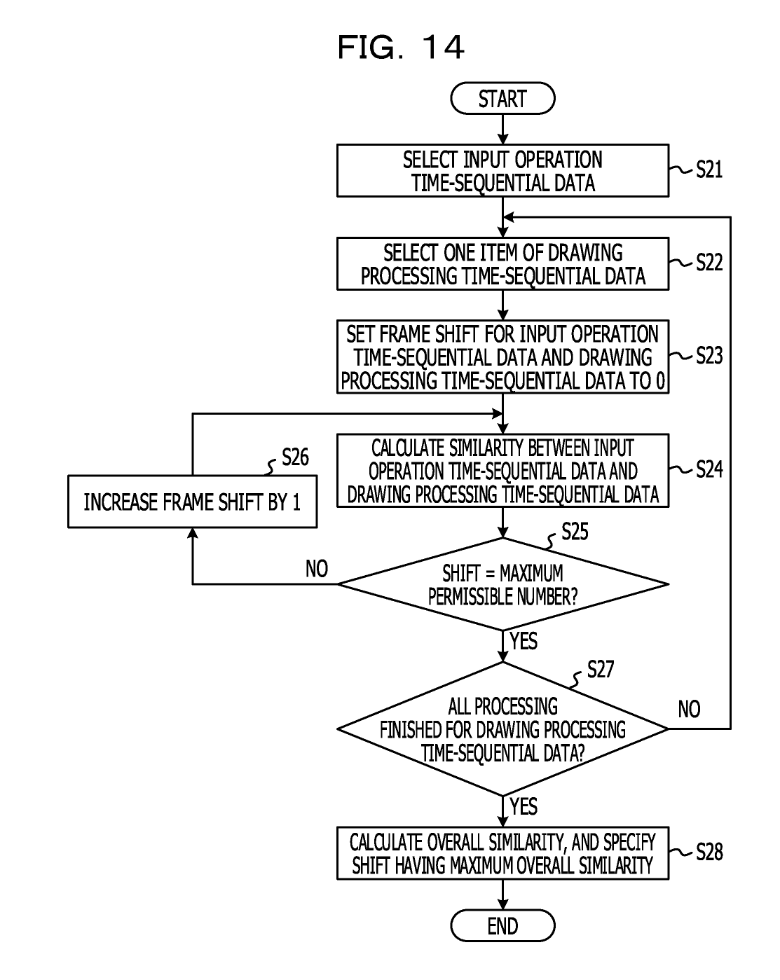

Next, processing executed by the association unit 14 is described using the flowchart depicted in FIG. 14. This processing is executed in continuation from the aforementioned processing of the time-sequential data generation unit 13.

In S21, the association unit 14 selects input operation time-sequential data 26 generated by the time-sequential data generation unit 13.

In S22, the association unit 14 selects one item of drawing processing time-sequential data 27 from among the drawing processing time-sequential data 27 generated by the processing of the time-sequential data generation unit 13.

In S23, the association unit 14 sets the frame shift for the input operation time-sequential data 26 selected in S21 and the drawing processing time-sequential data 27 selected in S22 to 0. In other words, the association unit 14 performs processing in such a way that the data items of the same frames of the input operation time-sequential data 26 and the drawing processing time-sequential data 27 correspond.

In S24, the association unit 14 calculates the similarity between the input operation time-sequential data 26 and the drawing processing time-sequential data 27. As an example of a specific method for calculating similarity, the association unit 14 sets each of the input operation time-sequential data 26 and the drawing processing time-sequential data 27 as an n-dimensional vector in which the numerical value of each frame serves as a coordinate, and calculates the cosine similarity between both vectors. The association unit 14 then stores similarity data 29 in which the calculated similarity and the current number of frame shifts are associated.

In S25, the association unit 14 determines whether or not the frame shift of the input operation time-sequential data 26 and the drawing processing time-sequential data 27 is the maximum permissible number. Processing advances to S26 if the frame shift is not the maximum permissible number, or processing advances to S27 if the frame shift is the maximum permissible number.

In S26, the association unit 14 increases the frame shift of the input operation time-sequential data 26 and the drawing processing time-sequential data 27 by 1.

In S27, the association unit 14 determines whether or not processing has been performed for all of the drawing processing time-sequential data 27. The processing of the association unit 14 is finished if processing for all of the drawing processing time-sequential data 27 has been performed, and processing returns to S22 if processing for all of the drawing processing time-sequential data 27 has not been performed.

In S28, based on the similarity data 29 stored in S25, the association unit 14 calculates the overall similarity between the input operation time-sequential data 26 and all of the drawing processing time-sequential data 27, for each frame shift. The calculation method for this overall similarity may be selected arbitrarily. For example, in the case where there are two types of drawing processing time-sequential data 27, and two similarities (similarity 1, similarity 2) are calculated with respect to each frame shift thereof, the association unit 14 is able to calculate an overall similarity by a calculation formula such as the following.

$$Overall similarity = \frac{2}{\frac{1}{Simirality 1} + \frac{1}{Simirality 2}} \qquad [ Equation 1 ]$$

It is possible for this calculation formula to be similarly applied also in the case where n number of similarities are to be calculated.

The association unit 14 then specifies the number of shifts for which the overall similarity is the highest. In other words, the association unit 14 specifies that the period in which the input operation time-sequential data 26 and the drawing processing time-sequential data 27 in the target frame group are the most similar is the period corresponding to a frame group shifted to later than the target frame group by the number of shifts in question. To further express in other words, the association unit 14 associates input operation data in the target frame group, and drawing processing data in a frame group shifted to later than the target frame group by the number of shifts in question.

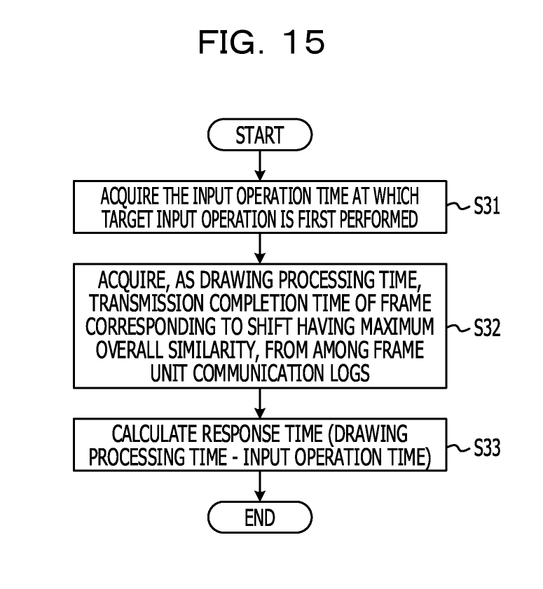

Next, processing executed by the response time calculation unit 15 is described using the flow chart depicted in FIG. 15. This processing is executed in continuation from the aforementioned processing of the association unit 14.

In S31, the response time calculation unit 15 refers to the frame unit communication log table 22, and acquires the input operation time at which the target input operation is first performed within the target frame group.

In S32, the response time calculation unit 15 refers to the frame unit communication log table 22, and, acquires, as the drawing processing time, the frame transmission completion time that is subsequent to the frame in which the target input operation is first performed within the target frame group, by the number of shifts for which the overall similarity specified by the association unit 14 is the highest.

In S33, the response time calculation unit 15 calculates the time difference (the time obtained by subtracting the input operation time from the drawing processing time) between the drawing processing time and the input operation time, namely the response time. As an example of the output of the calculated response time, the response time calculation unit 15 then writes, in the response time table 30, the input operation time, the drawing processing time, the IP addresses and so forth of the client 1 in which the input operation is performed and the service server 2 that transmitted the drawing instruction, the content of the input operation, the content of the drawing processing, and the response time.

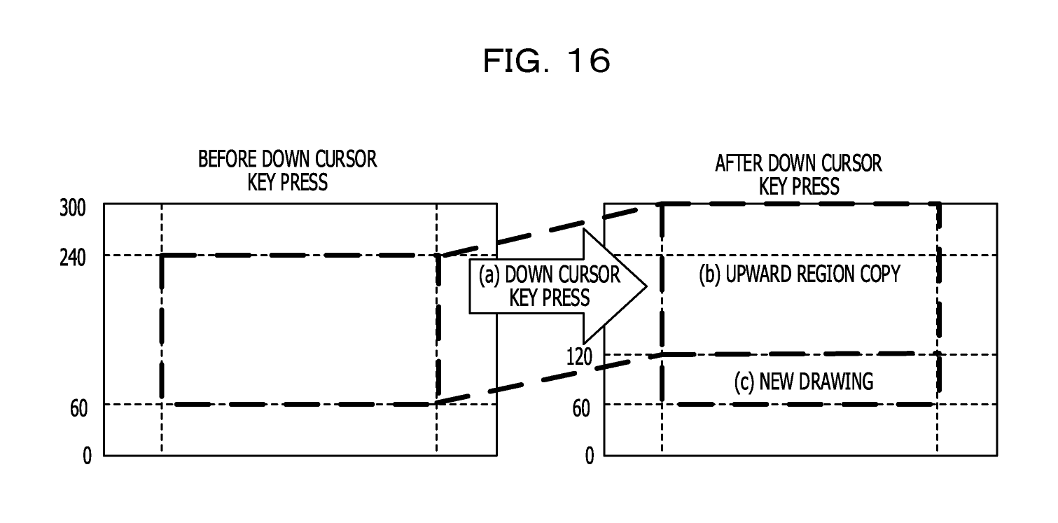

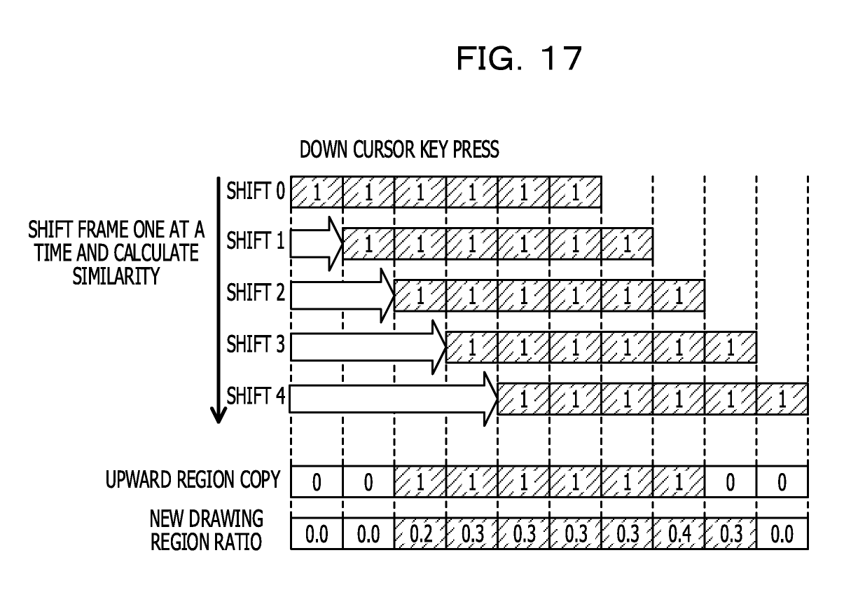

Here, from among the aforementioned processing of the capture server 4, the processing of the time-sequential data generation unit 13, the association unit 14, and the response time calculation unit 15 is described while referring to the specific examples of data depicted in FIG. 5 to FIG. 11 and the explanatory diagrams depicted in FIG. 16 and FIG. 17.

In this specific example, the input operation of “down cursor key press” in the period from after “2013/03/18 09:00:00.000000” to “2013/03/18 09:00:00.180000” is set as a response time measurement target. The data subsequent to “2013/03/18 09:00:00.120000” is not depicted in the data of the communication log table 21 of FIG. 5 and the frame unit communication log table 22 of FIG. 6.

First, the time-sequential data generation unit 13 forms the communication logs of the communication log table 21 depicted in FIG. 5 into groups in such a way that a communication log in which the command is a frame transmission completion command is at the end of each frame. The time-sequential data generation unit 13 then writes the grouped communication logs in the frame unit communication log table 22 depicted in FIG. 6. Frame IDs are assigned in order from 1 in the specific example of FIG. 6; however, [time] values for example may be used as they are as frame IDs to ensure uniqueness. Here, in the communication logs of FIG. 5, the argument “NoChangeFrame” of the frame transmission completion command having a [time] of “2013/03/18 09:00:00.090000” is 2, and a drawing instruction from the service server 2 has not been generated since “2013/03/18 09:00:00.000000”, which is the [time] of the immediately preceding frame transmission completion command. Therefore, the time-sequential data generation unit 13 divides, by 3, the time difference from “2013/03/18 09:00:00.000000” that is the [time] of the immediately preceding frame transmission completion command, and supplements frame transmission completion commands at “2013/03/18 09:00:00.030000” and “2013/03/18 09:00:00.060000” (S11).

The time-sequential data generation unit 13 then selects “down cursor key press”, which is the current target input operation, from the input operation table 23 depicted in FIG. 7A (S12). In addition, reference is made to the frame unit communication log table 22 depicted in FIG. 6, and frame ID 2 to frame ID 7 are selected as a target frame group in which the input operation data of “down cursor key press” is included. Based on [range] in the input operation table 23 depicted in FIG. 7A, the time-sequential data generation unit 13 then, with regard to frame ID 2 to frame ID 7, generates the input operation time-sequential data 26 depicted in FIG. 9A, with frames that include the input operation data of “down cursor key press” as “1” and frames that do not include this input operation data as “0” (S13).

Next, the time-sequential data generation unit 13 refers to the input/drawing correspondence table 25 depicted in FIG. 8, and acquires “upward region copy” and “new drawing region ratio”, which are target drawing processing included in targets for calculating the similarity with “down cursor key press” (S14).

“Upward region copy” and “new drawing region ratio” are both drawing processing generated when the screen scrolls upward. As depicted in FIG. 16, the screen scrolls upward due to (a) the down cursor key being pressed. In this way, it is possible for the change on the screen of the screen scrolling upward to be expressed by (b) a partial region of the displayed screen being designated and copied upward from below, and (c) the screen being newly drawn in the region below the copied portion. The new drawing region ratio indicates the ratio taken up by the number of pixels of the region in which the screen is newly drawn, with respect to the number of pixels of the entire screen. It is possible for the number of pixels of the entire screen to be acquired when communication between the client 1 and the service server 2 is started for example. If it is not possible for the number of pixels of the entire screen to be acquired, for example, the largest value for the number of pixels of regions in which a new screen has been drawn in the past may be used.

The time-sequential data generation unit 13, first, selects “upward region copy” from the drawing processing table 24 depicted in FIG. 7B (S15). In addition, the time-sequential data generation unit 13 specifies frame ID 2 to frame ID 7 and four (the maximum permissible number 28 depicted in FIG. 9C) frames continuing from frame ID 7. The time-sequential data generation unit 13 then refers to [command] and [command argument] in the frame unit communication log table 22, and specifies frames in which the drawing processing data of “upward region copy” is included. Based on [range] in the drawing processing table 24, the time-sequential data generation unit 13 then generates the drawing processing time-sequential data 27 depicted in FIG. 9B with frames that include the drawing instruction data of “upward region copy” as “1” and frames that do not include this drawing instruction data as “0” (S16). Similarly, the time-sequential data generation unit 13 refers to [command] and [command argument] in the frame unit communication log table 22, and specifies frames in which the drawing processing data of “new drawing” is included. Based on [range] in the drawing processing table 24, the time-sequential data generation unit 13 then, with regard to “new drawing region ratio”, generates the drawing processing time-sequential data 27 depicted in FIG. 9B with “new drawing region ratio” as a value between “0” (no drawing) and “1” (entire screen drawing) (S15, S16).

Next, the association unit 14 selects the input operation time-sequential data 26 of “down cursor key press” depicted in FIG. 9A (S21). The association unit 14 selects the drawing processing time-sequential data 27 of “upward region copy” from among the drawing processing time-sequential data 27 depicted in FIG. 9B (S22). The association unit 14 then calculates the similarity between the input operation time-sequential data 26 of “down cursor key press” and the drawing processing time-sequential data 27 of “upward region copy” while shifting frames one by one, as depicted in FIG. 17 (S23 to S26). Specifically, the association unit 14, first, sets the frame shift to 0 in such a way that values corresponding to the same frame ID as the data of the same frame ID have the same coordinate (S23). The association unit 14 calculates the similarity between the input operation time-sequential data 26 of “down cursor key press” and the drawing processing time-sequential data 27 of “upward region copy” while the frame shift is 0 in this way, and obtains a value of “0.894”. The association unit 14 then stores, as depicted in FIG. 10, the similarity data 29 in which the similarity “0.894” is associated with the frame shift being 0 (S24). Similarly, the association unit 14 calculates similarities until the shift becomes the maximum permissible number of 4, and adds these to the similarity data 29.

In addition, the association unit 14 selects the drawing processing time-sequential data 27 of “new drawing region ratio” from among the drawing processing time-sequential data 27 depicted in FIG. 9B, and performs the same processing.

Based on the similarity calculated for each “upward region copy” and “new drawing region ratio”, the association unit 14 then calculates the overall similarity for each of the states from the state where the shift is 0 to the state where the shift is 4, and records the overall similarities as depicted in FIG. 10. The association unit 14 then specifies that the shift for which the overall similarity is the highest is “2” (S25). Namely, this means that there is a high possibility of the drawing processing for “upward region copy” and “new drawing region ratio” in response to the input operation of “down cursor key press” having been performed two frames subsequent to the input operation of “down cursor key press”. To further express in other words, this means that the input operations of frame ID 2 to frame ID 7 and the drawing processing of frame ID 4 to frame ID 9 two frames thereafter are associated.

Next, the response time calculation unit 15 refers to the frame unit communication log table 22 depicted in FIG. 6, and in frame ID 2 to frame ID 7, acquires, as the input operation time, the time at which “down cursor key press” is first performed, namely “2013/03/18 09:00:00.015000” of frame ID 2 (S31). In addition, the response time calculation unit 15 acquires, as the drawing processing time, “2013/03/18 09:00:00.090000”, which is the frame transmission completion time of the frame of the shift for which the overall similarity is the highest, “2” frames subsequent to frame ID 2, namely frame ID 4 (S32). The response time calculation unit 15 then calculates the response time “0.075000”, which is the time difference obtained by subtracting the input operation time from the drawing processing time. The response time calculation unit 15 then writes the calculated response time in the response time table 30 as depicted in FIG. 11 (S33).

According to the present embodiment, the period in which the drawing processing corresponding to the input operation in the client 1 is transmitted from the service server 2 is specified by calculating the similarity between the occurrence status of the input operation data and the occurrence status of the drawing processing data. It is therefore possible to measure the response time obtained by subtracting the input operation time from the drawing processing time, namely the response time from the input operation in the client 1 being performed, to an instruction for drawing processing for a screen corresponding to that input operation being returned to the client 1. Therefore, based on the response time, it is possible to measure performance and evaluate quality in the remote desktop system.

Furthermore, in the present embodiment, if there are a plurality of target drawing processing for which the similarity with a target input operation is to be calculated, the overall similarity between input operation time-sequential data 26 and a plurality of drawing processing time-sequential data 27 is calculated. Thus, it is possible to suitably specify the number of frame shifts serving as the entirety of the target drawing processing for one target input operation, and to suitably calculate the response time.

In addition, in the present embodiment, communication logs are formed into groups in frame units that are the minimum units in which screen drawing processing is performed, the shift for which the similarity is the highest is calculated in frame units, and the frame transmission completion time that is subsequent by the number of frame shifts for which the similarity is the highest is used to calculate the response time. The calculation accuracy of the response time therefore increases. However, the processing unit for the calculation of shifts is not restricted to such frame units, and an arbitrary time unit for example may be used.

Furthermore, in the present embodiment, frame transmission completion commands are supplemented for periods in which an update is not generated for the screen displayed by the client 1 and drawing processing data and a frame transmission completion command data are not transmitted. Therefore, even if there is a period in which a frame transmission completion command is not transmitted, it is possible for the forming of communication logs into groups to be suitably performed in time units corresponding to the frames, and it is possible for the calculation of a response time based on the number of frame shifts for which the similarity is the highest to be suitably realized.

In the present embodiment, in the calculation of the time difference with the input operation time at which the target input operation is first performed within the target frame group, the frame transmission completion time of the frame that is subsequent to the frame in which the target input operation is first performed, by the number of shifts for which the overall similarity is the highest is used as the drawing processing time. However, there is no restriction that only the frame transmission completion time is to be used, and, for example, the time at which separate drawing processing data is last transmitted in the frame in question may be used.

Furthermore, in the present embodiment, the response time calculation unit 15 outputs the response time to the response time table 30; however, the response time may be output by another method. For example, the response time calculation unit 15 may display the response time on a display or output a document.

In addition, the technology described in the present embodiment is not restricted to being realized by the capture server 4, and, for example, may be realized by another server that has additionally acquired data from the capture server 4.

Here, in the present embodiment, there are no particular limitations with respect to the input operations that serve as target input operations to be response time measurement targets. However, if the input operation incidence of the target input operation is low for example, the possibility of an erroneous association being made even with a drawing that does not actually correspond to the target input operation becomes relatively high. Therefore, a threshold value may be provided for the incidence of an input operation, and only when an input operation that has continued for a predetermined incidence or more has been performed may the input operation serve as a target input operation. In this case, it is deemed that a continuous input operation has been performed when the operation interval occurs within a predetermined interval. The accuracy with which a drawing instruction transmitted in response to a target input operation is specified therefore increases.

### Embodiment 2

In the present embodiment, in addition to embodiment 1, it is possible for the association of drawing processing with an input operation to be suitably performed even when drawing processing data that is unrelated to the input operation in the client 1 is transmitted from the service server 2.

With the increase in the resolution of display devices, it has also become common for a plurality of applications to be displayed at the same time on a screen. There has also been an increase in applications for which the display is automatically updated as time elapses, unrelated to input operations performed by the user. Examples of these kinds of applications are applications for which the display is updated by news and social network updates for example.

If these kinds of applications are executed by a remote desktop system, instructions for drawing processing that is unrelated to input operations in the client 1 are transmitted from the service server 2, and it is sometimes difficult for the drawing processing corresponding to an input operation to be correctly associated. Embodiment 2 corresponds to the case where drawing processing which is treated as noise that is unrelated to input operations occurs in this way. It is possible for embodiment 2 to be applied to, in particular, the case where drawing instructions for input operations occur more often than drawing instructions that are unrelated to input operations.

Within embodiment 2, descriptions of content that is the same as embodiment 1 have in principle been omitted.

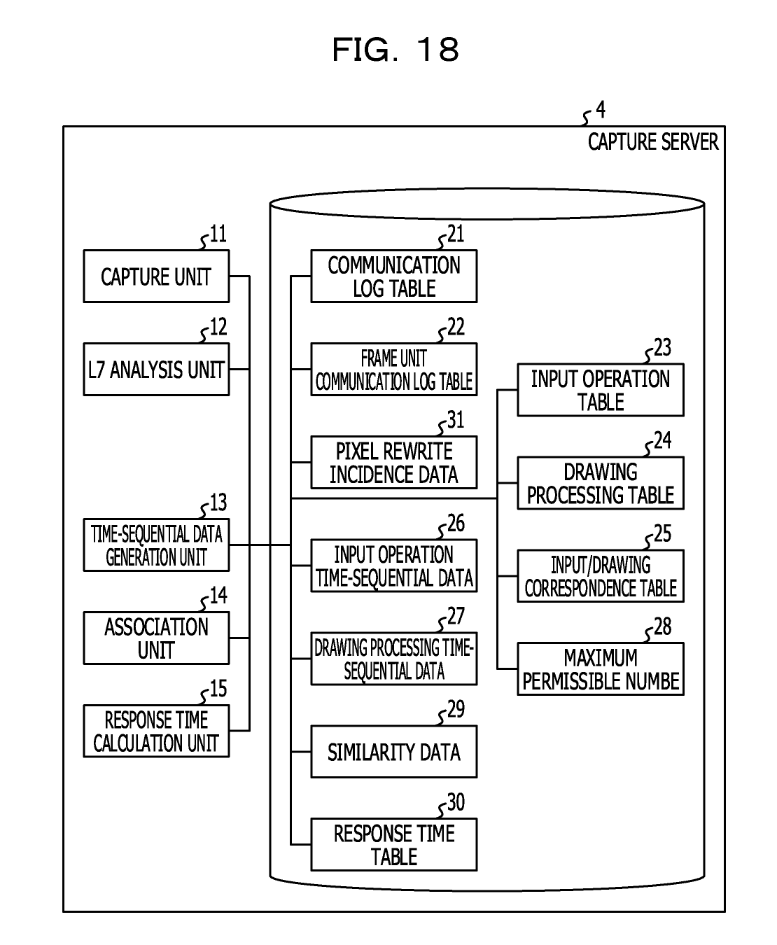

FIG. 18 depicts the overall configuration of the capture server 4 in embodiment 2. The capture server 4 in embodiment 2, in addition to embodiment 1, stores pixel rewrite incidence data 31 in the storage unit.

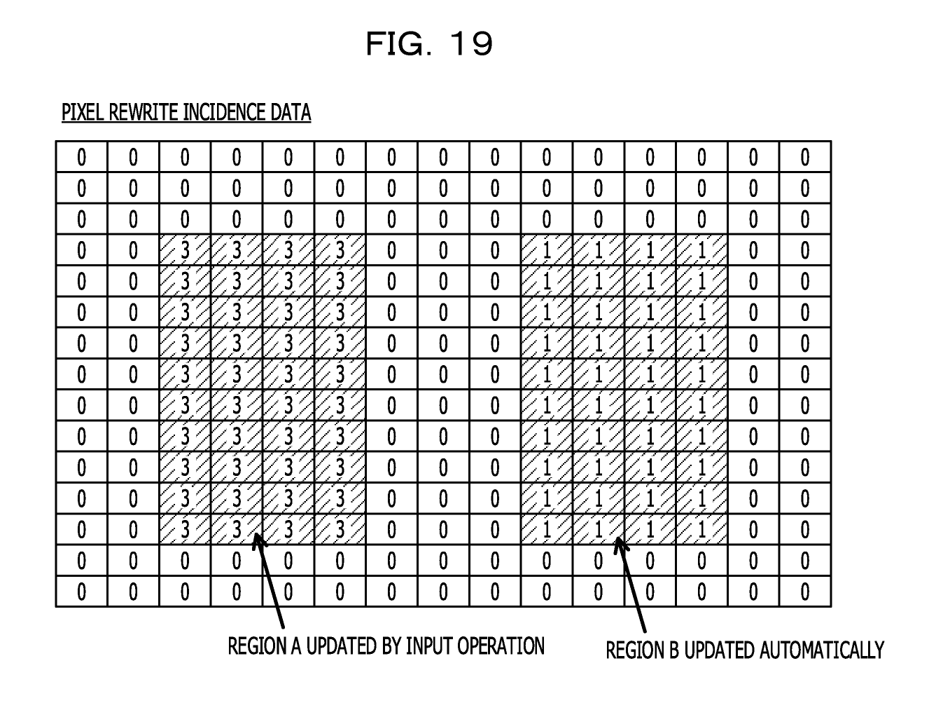

As depicted in FIG. 19, the pixel rewrite incidence data 31 is two-dimensional array data in which the rewrite incidence of each pixel in one frame is retained according to coordinates corresponding to the pixels. Due to the manner of depiction, in FIG. 19 the number of coordinates of the pixels (the size of the rows and columns) displayed is less than that of an actual screen.

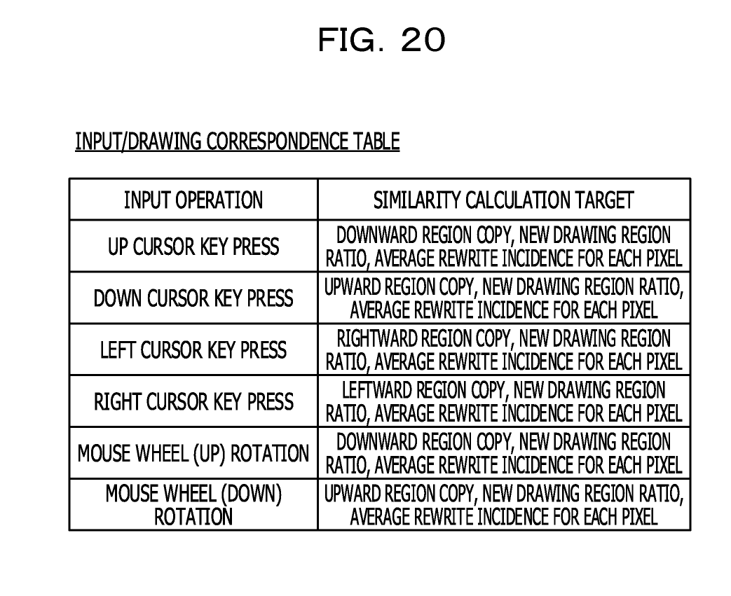

FIG. 20 is an example of the data of the input/drawing correspondence table 25 in embodiment 2. In embodiment 2, an “average rewrite incidence for each pixel” is included in [similarity calculation target] in accordance with the content of the input operation.

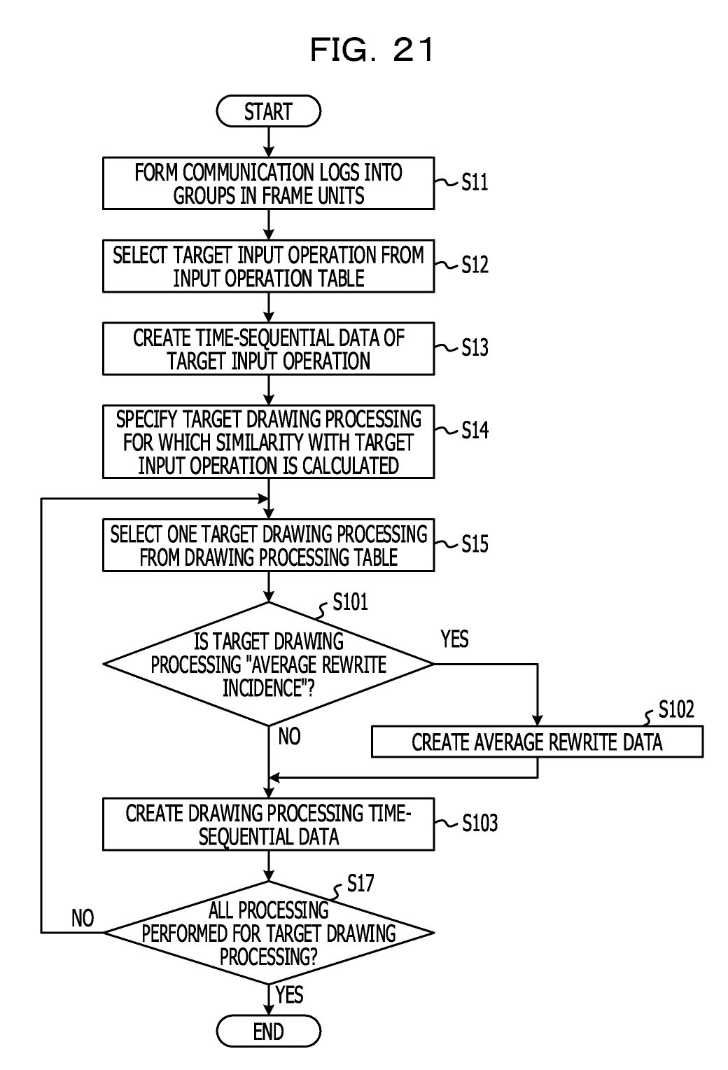

Next, from among the processing executed by the capture server 4, the processing of the time-sequential data generation unit 13 is described. FIG. 21 depicts the processing of the time-sequential data generation unit 13 in embodiment 2.

The processing from S11 to S15 is the same as in embodiment 1 and a description thereof is therefore omitted.

In S101, the time-sequential data generation unit 13 determines whether or not the target drawing processing is “average rewrite incidence for each pixel”. Processing advances to S102 when the target drawing processing is “average rewrite incidence for each pixel” (yes), or processing advances to S103 when that is not the case (no).

In S102, the time-sequential data generation unit 13 refers to the frame unit communication log table 22, and generates pixel rewrite incidence data 31 and stores this in the storage unit. Specifically, the time-sequential data generation unit 13, first, acquires the number of pixels of the entire screen. As previously mentioned, the number of pixels of the entire screen may be acquired when communication between the client 1 and the service server 2 starts for example, or the largest value for the number of pixels of a region in which a new screen has been drawn in the past may be used. The time-sequential data generation unit 13 then generates initial-state pixel rewrite incidence data 31, which is a two-dimensional array corresponding to the coordinates of the pixels of the entire screen, and sets the initial value of the elements to 0. In addition, with regard to the target frame group and frames of the maximum permissible number continuing from the target frame group, the time-sequential data generation unit 13 refers to the command arguments of drawing processing data such as a region copy and new drawing for example, and specifies which region is being rewritten. The time-sequential data generation unit 13 then updates the values of the elements corresponding to the coordinates of the pixels of a region (update target region) that has been rewritten by the drawing processing, with the number of times that the pixels have been rewritten.

In S103, with regard to the target frame group and the frames of the maximum permissible number continuing from the target frame group, the time-sequential data generation unit 13 refers to the frame unit communication log table 22 and thereby generates drawing processing time-sequential data 27 indicating the occurrence status of drawing processing data that indicates the target drawing processing in the frames. Specifically, the time-sequential data generation unit 13 refers to the commands and the command arguments of the frame unit communication log table 22, and based on the ranges of the input operation table 23, converts the content of the target drawing processing performed in the frames into numerical values (normalization).

This conversion into numerical values is realized by processing such as the following if the target drawing processing is “average rewrite incidence for each pixel”. Namely, the time-sequential data generation unit 13 (1) refers to the frame unit communication log table 22 and acquires the number of coordinates of the pixels updated in each of the frames, and (2) with respect to the acquired coordinates, refers to the pixel rewrite incidence data 31 and acquires rewrite incidences. The time-sequential data generation unit 13 then calculates the total value (Sum) of the rewrite incidences acquired in (2), and sets the value (Sum/Cpoints) obtained by dividing the total value by the number of coordinates (Cpoints) acquired in (1) as the “average rewrite incidence for each pixel”.

S17 is the same as in embodiment 1 and a description thereof is therefore omitted. The processing of the association unit 14 and the response time calculation unit 15 is also the same as in embodiment 1 and descriptions thereof are therefore omitted.

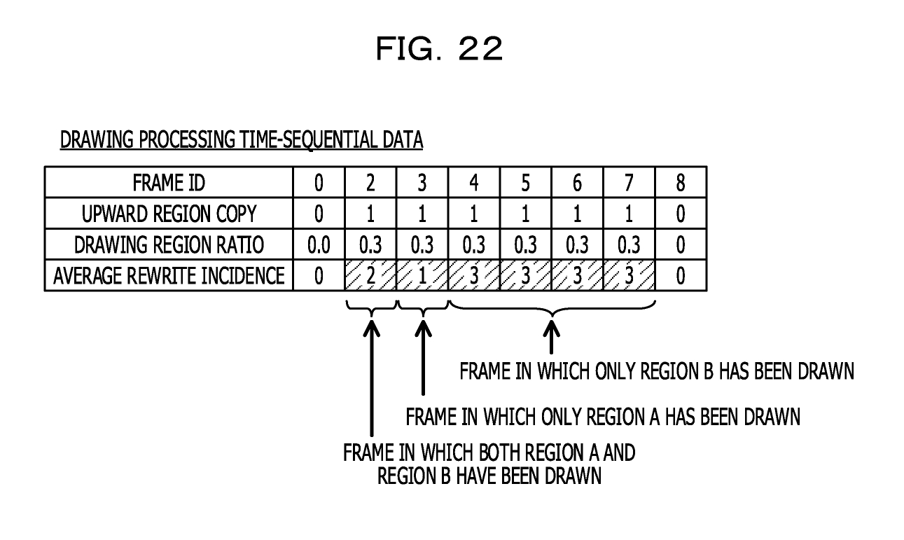

Here, the aforementioned numerical value conversion of the “average rewrite incidence for each pixel” is described by giving a specific example of the data while referring to FIG. 19 and FIG. 22.

For example, a description is given using an example in which, as represented by the pixel rewrite incidence data 31 depicted in FIG. 19, on a screen there is a region A that displays an application A for which the screen is updated by an input operation, and a region B that displays an application B for which the screen is updated automatically. This pixel rewrite incidence data 31 is of the frame having frame ID 2.

In the specific example depicted in FIG. 19, in region A, an input operation and screen drawing that occur three times in one frame are generated, and in region B, screen drawing that occurs once is generated. In this case, the coordinates in which updates have occurred are region A and region B, and the number of coordinates of the updated pixels is 40 in region A and 40 in region B, and is therefore 80 for the entire screen. The total value of the rewrite incidence of the coordinates is 160 combining 120 (3*40) for region A and 40 (1*40) for region B. The average rewrite incidence for each pixel is therefore “2” obtained by dividing 160 by 80. As depicted in FIG. 22, the time-sequential data generation unit 13 sets “2” as the average rewrite incidence for each pixel of frame ID 2 and generates drawing processing time-sequential data 27.

As depicted in the specific example of the drawing processing time-sequential data 27 of FIG. 22, the average rewrite incidence for each pixel is “1” in the frame in which only region B is updated. In contrast, the average rewrite incidence for each pixel is “3” in the frames in which only region A is updated.

According to the present embodiment, in addition to the effects afforded by embodiment 1, effects such as the following are additionally demonstrated. Namely, according to the present embodiment, the drawing processing time-sequential data 27 of the “average rewrite incidence for each pixel” is generated. In this drawing processing time-sequential data 27 of the average rewrite incidence, if drawing instructions for input operations occur a greater number of times than drawing instructions unrelated to input operations, the values in frames in which drawing instructions unrelated to input operations have been performed are lower than in frames in which only drawing instructions for input operations have been performed. Therefore, even if a drawing instruction unrelated to an input operation has occurred, the calculation of the similarity with input operation time-sequential data 26 is performed in a comparatively accurate manner. Therefore, there is an increase in the accuracy with which a drawing instruction that is transmitted in response to a target input operation is specified.

The functional configuration and the physical configuration of the information processing device described in the present specification are not restricted to the aforementioned modes, and, for example, it is possible for these to be implemented by integrating the functions and the physical resources, and, contrastingly, it is possible for these to be implemented by being further distributed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A performance measurement method, comprising:
acquiring first time-sequential data including input operation data that is transmitted from a first computer to a second computer, and a first time information indicating a time when the input operation data being transmitted from the first computer, the input operation data being associated with the first time information;
acquiring second time-sequential data including drawing processing data that is transmitted from the second computer to the first computer, and a second time information indicating a time when the drawing processing data being transmitted from the second computer, the drawing processing data being associated with the second time information;
specifying a similar period in which the input operation data and the drawing processing data are similar; and
calculating a difference between the first time information and the second time information corresponding to the similar period as a response time of the drawing processing data.

2. The performance measurement method according to claim 1, wherein
the acquiring of the second time-sequential data includes:
specifying the second time-sequential data for each type of the drawing processing when there are a plurality of types of drawing processing indicated by the drawing processing data, and
the specifying of the similar period includes:
calculating, for each type of the drawing processing, a similarity between the first time-sequential data and the second time-sequential data; and
specifying, as the similar period, a period having the highest overall similarity calculated based on the similarity of each type of the drawing processing.

3. The performance measurement method according to claim 1, wherein
the acquiring of the second time-sequential data includes:
specifying a plurality of pixels of an update target region of a screen indicated by the drawing processing data; and
calculating an average rewrite incidence of each pixel, for the plurality of pixels in the predetermined period, and
the specifying of the similar period includes:
calculating, for each pixel, a similarity between the first time-sequential data and the average rewrite incidence; and
specifying, as the similar period, a period having the highest overall similarity calculated based on the similarity of each pixel.

4. The performance measurement method according to claim 1, further comprising:
forming the input operation data and the drawing processing data into groups for each frame, wherein
the acquiring of the first time-sequential data includes:
specifying the first time-sequential data in each of the groups included in a predetermined period, and
the acquiring of the second time-sequential data includes:
specifying the second time-sequential data in each of the groups included in the predetermined period and in each of the groups of a predetermined number continuing from the predetermined period, and
the specifying of the similar period includes:
calculating a similarity between the first time-sequential data in each of the groups included in the predetermined period, and the second time-sequential data in each of the groups included in each period in which the predetermined period is shifted to thereafter one frame at a time up to the predetermined number; and
specifying a period in which the similarity is the highest within the periods.

5. The performance measurement method according to claim 4, wherein
the acquiring of the second time-sequential data includes acquiring the drawing processing data including a frame transmission completion command indicating that transmission of drawing processing data with which one frame is drawn has been completed, and frame transmission completion command data including an argument that indicates a number of frames in which a screen update has not been performed immediately prior thereto, and
the specifying of the similar period includes:
inserting frame transmission completion command data of a number corresponding to a value of the argument into the drawing processing data, when the argument of the frame transmission completion command data is greater than zero; and
forming drawing processing data that is transmitted between one item of frame transmission completion command data and frame transmission completion command data immediately prior thereto into a group as one frame.

6. The performance measurement method according to claim 4, wherein the calculating of the similarity includes:
setting each of the first time-sequential data and the second time-sequential data as a vector in which a numerical value of each frame serves as a coordinate, and
calculating a cosine similarity between both the vector of the first time-sequential data and the vector of the second time-sequential data.

7. The performance measurement method according to claim 1, wherein
the acquiring of the first time-sequential data includes capturing the input operation data which are binary data port mirrored by a switch, and
the acquiring of the second time-sequential data includes capturing the drawing processing data which are binary data port mirrored by the switch.

8. The performance measurement method according to claim 1, further comprising:
analysing the binary data of the input operation data and the drawing processing data, and
generating a communication log by converting the binary data.

9. A performance measurement device, comprising:
a memory; and
a processor coupled to the memory and configured to:
acquire first time-sequential data including input operation data that is transmitted from a first computer to a second computer, and a first time information indicating a time when the input operation data being transmitted from the first computer, the input operation data being associated with the first time information;
acquire second time-sequential data including drawing processing data that is transmitted from the second computer to the first computer, and a second time information indicating a time when the drawing processing data being transmitted from the second computer, the drawing processing data being associated with the second time information;
specify a similar period in which the input operation data and the drawing processing data are similar; and
calculate a difference between the first time information and the second time information corresponding to the similar period as a response time of the drawing processing data.

10. The performance measurement device according to claim 9, wherein the processor is configured to:
specify the second time-sequential data for each type of the drawing processing when there are a plurality of types of drawing processing indicated by the drawing processing data,
calculate, for each type of the drawing processing, a similarity between the first time-sequential data and the second time-sequential data, and
specify, as the similar period, a period having the highest overall similarity calculated based on the similarity of each type of the drawing processing.

11. The performance measurement device according to claim 9, wherein the processor is configured to:
specify a plurality of pixels of an update target region of a screen indicated by the drawing processing data,
calculate an average rewrite incidence of each pixel, for the plurality of pixels in the predetermined period,
calculate, for each pixel, a similarity between the first time-sequential data and the average rewrite incidence, and
specify, as the similar period, a period having the highest overall similarity calculated based on the similarity of each pixel.

12. The performance measurement device according to claim 9, wherein the processor is configured to:
form the input operation data and the drawing processing data into groups for each frame,
specify the first time-sequential data in each of the groups included in a predetermined period,
specify the second time-sequential data in each of the groups included in the predetermined period and in each of the groups of a predetermined number continuing from the predetermined period,
calculate a similarity between the first time-sequential data in each of the groups included in the predetermined period, and the second time-sequential data in each of the groups included in each period in which the predetermined period is shifted to thereafter one frame at a time up to the predetermined number, and
specify a period in which the similarity is the highest within the periods.

13. The performance measurement device according to claim 12, wherein the processor is configured to:
acquire the drawing processing data including a frame transmission completion command indicating that transmission of drawing processing data with which one frame is drawn has been completed, and frame transmission completion command data including an argument that indicates a number of frames in which a screen update has not been performed immediately prior thereto,
insert frame transmission completion command data of a number corresponding to a value of the argument into the drawing processing data, when the argument of the frame transmission completion command data is greater than zero, and
form drawing processing data that is transmitted between one item of frame transmission completion command data and frame transmission completion command data immediately prior thereto into a group as one frame.

14. A non-transitory computer-readable storage medium storing a performance measurement program causing a computer to execute a process, the process comprising:
acquiring first time-sequential data including input operation data that is transmitted from a first computer to a second computer, and a first time information indicating a time when the input operation data being transmitted from the first computer, the input operation data being associated with the first time information;
acquiring second time-sequential data including drawing processing data that is transmitted from the second computer to the first computer, and a second time information indicating a time when the drawing processing data being transmitted from the second computer, the drawing processing data being associated with the second time information;
specifying a similar period in which the input operation data and the drawing processing data are similar; and
calculating a difference between the first time information and the second time information corresponding to the similar period as a response time of the drawing processing data.
